(19) United States
(12) Patent Application Publication
(10) Pub. No.: US 2026/0293983 A1
(43) Pub. Date: Oct. 1, 2026

(54) AEROSOL GENERATING DEVICE AND HEATER FOR SAME

(71) Applicant: SHENZHEN FIRST UNION TECHNOLOGY CO., LTD., Shenzhen, Guangdong (CN)

(72) Inventors: Wei CHEN, Shenzhen, Guangdong (CN); Ruilong HU, Shenzhen, Guangdong (CN); Zhongli XU, Shenzhen, Guangdong (CN); Yonghai LI, Shenzhen, Guangdong (CN)

(73) Assignee: SHENZHEN FIRST UNION TECHNOLOGY CO., LTD., Shenzhen, Guangdong (CN)

(21) Appl. No.: 19/479,630

(22) PCT Filed: Apr. 23, 2024
(86) PCT No.: PCT/CN2024/089378

§ 371 Date: Oct. 28, 2025

(30) Foreign Application Priority Data
Apr. 28, 2023 (CN) 202310488172.7

(51) Int. Cl. A24F 40/46; A24F 40/20; H01M 50/247; H05B 3/03

(52) U.S. Cl. CPC A24F 40/46; A24F 40/20; H01M 50/247; H05B 3/03; H01M 2220/30

(57) ABSTRACT

An aerosol generating device and a heater for an aerosol generating device. The aerosol generating device includes a battery core configured to supply power; and a heater. The heater includes a first heating element, a second heating element, and a third heating element arranged in sequence along a longitudinal direction; and a first electrode, a second electrode, and a third electrode, operably electrically connected to the battery core, and configured to guide a current on the heater. The first heating element and the second heating element are electrically connected in parallel between the first electrode and the second electrode. The third heating element is connected between the first electrode and the third electrode. During operation, the first heating element and the second heating element can only be simultaneously heated in parallel, and the third heating element is selectively enabled to participate in simultaneous heating or not.

### CROSS-REFERENCE TO RELATED APPLICATIONS

This application claims priority to Chinese Patent Application No. 202310488172.7, filed with the China National Intellectual Property Administration on Apr. 28, 2023 and entitled “AEROSOL GENERATING DEVICE AND HEATER FOR AEROSOL GENERATING DEVICE”, which is incorporated herein by reference in its entirety.

### TECHNICAL FIELD

Embodiments of this application relate to the field of heat-not-burn aerosol generating technologies, and in particular, to an aerosol generating device and a heater for an aerosol generating device.

### BACKGROUND

During use of tobacco products (for example, cigarettes and cigars), tobaccos are burnt to generate tobacco vapor. An attempt has been made to replace these tobacco-burning products by producing products that release compounds without burning.

An example of such products is a heating device, which releases compounds by heating tobacco rather than burning the material. For example, the material may be tobacco or other non-tobacco products, and these non-tobacco products may or may not contain nicotine. A known heating device includes a plurality of tubular heaters arranged at intervals along the longitudinal direction and surrounding different sections of tobacco or other non-tobacco products. Further, these spaced tubular heaters are independently activated to heat the different sections of tobacco or other non-tobacco products respectively.

### SUMMARY

An embodiment of this application provides an aerosol generating device, configured to heat an aerosol generating article to generate an aerosol, and including:
a battery core, configured to supply power; and
a heater, configured to heat the aerosol generating article, where the heater includes at least:
a first heating element, a second heating element, and a third heating element arranged in sequence along a longitudinal direction; and
a first electrode, a second electrode, and a third electrode, operably electrically connected to the battery core, to guide a current on the heater, where
the first heating element and the second heating element are electrically connected in parallel between the first electrode and the second electrode; and the third heating element is electrically connected between the first electrode and the third electrode.

In some embodiments, the aerosol generating device further includes:
a circuit, configured to:
electrically connect, during a first time phase, one of a positive electrode and a negative electrode of the battery core to the first electrode, and electrically connect the other to the second electrode, so that the first heating element and the second heating element are simultaneously heated in parallel; and
electrically connect, during a second time phase, one of a positive electrode and a negative electrode of the battery core to the first electrode, and electrically connect the other to the second electrode and the third electrode simultaneously, so that the first heating element, the second heating element, and the third heating element are simultaneously heated in parallel.

In some embodiments, the first heating element and the second heating element can only simultaneously start heating in parallel.

In some embodiments, the first heating element and the second heating element cannot start heating independently of each other.

In some embodiments, during the second time phase, when the first heating element, the second heating element, and the third heating element are simultaneously heated in parallel, a power of the third heating element is greater than a power of the first heating element and a power of the second heating element.

In some embodiments, along the longitudinal direction of the heater, the first heating element has a first length dimension, the second heating element has a second length dimension, and the third heating element has a third length dimension; and
the first length dimension and/or the second length dimension is less than the third length dimension.

In some embodiments, the first electrode extends from the first heating element to the third heating element along the longitudinal direction of the heater; and/or
the second electrode extends from the first heating element to the second heating element along the longitudinal direction of the heater; and/or
the third electrode is arranged to extend on the third heating element along the longitudinal direction of the heater.

In some embodiments, the first electrode includes a first width portion and a second width portion arranged in sequence along the longitudinal direction, and a width dimension of the first width portion is less than a width dimension of the second width portion;
the first width portion extends from the first heating element to the second heating element; and
the second width portion is bonded to the third heating element.

In some embodiments, a width dimension of the second electrode is less than a width dimension of the third electrode.

In some embodiments, the aerosol generating device further includes:
one or more first empty electrodes, arranged to extend from the first heating element to the second heating element, to reduce resistance of the first heating element and the second heating element, where the first empty electrode is not electrically connected to the battery core.

In some embodiments, the first empty electrode includes a third width portion and a fourth width portion arranged in sequence along the longitudinal direction, where
the third width portion is bonded to the first heating element, and the fourth width portion is bonded to the second heating element; and the third width portion has a width dimension different from that of the fourth width portion.

In some embodiments, the aerosol generating device further includes:
one or more second empty electrodes, arranged on the third heating element at intervals along a circumferential direction, to reduce resistance of the third heating element, where the second empty electrode is not electrically connected to the battery core.

In some embodiments, the circuit is configured to:
heat, during the first time phase, the first heating element and the second heating element from a room temperature to a first target temperature, and enable the third heating element to be heated to a second target temperature by receiving heat from the second heating element; and
heat, during the second time phase, the first heating element and the second heating element to a third target temperature higher than the first target temperature, and heat the third heating element to a fourth target temperature higher than the second target temperature.

In some embodiments, the aerosol generating device further includes:
a chamber, configured to receive an aerosol generating article; and
an opening, where in use, the aerosol generating article is at least partially received in the chamber or removed from the chamber through the opening, and
the first heating element and the second heating element are closer to the opening than the third heating element.

In some embodiments, the heater further includes:
a substrate, at least partially surrounding or defining the chamber, where
the first heating element includes a coating or a thin film or a heating mesh bonded to the substrate;
and/or the second heating element includes a coating or a thin film or a heating mesh bonded to the substrate;
and/or the third heating element includes a coating or a thin film or a heating mesh bonded to the substrate.

In some embodiments, the first heating element includes at least one of an infrared heating element or a resistive heating element; and/or
the second heating element includes at least one of the infrared heating element or the resistive heating element; and/or
the third heating element includes at least one of the infrared heating element or the resistive heating element.

In some embodiments, the aerosol generating device further includes:
a circuit, configured to electrically connect one of a positive electrode and a negative electrode of the battery core to the second electrode, and electrically connect the other to the third electrode, so that the first heating element and the second heating element are connected in parallel and then simultaneously heated in series with the third heating element.

Another embodiment of this application further provides an aerosol generating device, configured to heat an aerosol generating article to generate an aerosol, including:
a battery core, configured to supply power;
a heater, configured to heat an aerosol generating article, where the heater includes at least a first heating element, a second heating element, and a third heating element arranged in sequence along a longitudinal direction; and
a circuit, configured to:
electrically connect only the first heating element and the second heating element in parallel to the battery core during a first time phase, so that only the first heating element and the second heating element are simultaneously heated; and
electrically connect the first heating element, the second heating element, and the third heating element in parallel to the battery core during a second time phase, so that the first heating element, the second heating element, and the third heating element are simultaneously heated.

Still another embodiment of this application further provides a heater for an aerosol generating device, including:
a tubular substrate;
a first heating element, a second heating element, and a third heating element arranged on the substrate in sequence along a longitudinal direction; and
a first electrode, a second electrode, and a third electrode, configured to guide a current on the heater, where
the first heating element and the second heating element are electrically connected in parallel between the first electrode and the second electrode; and the third heating element is electrically connected between the first electrode and the third electrode.

In the foregoing aerosol generating device, the first heating element and the second heating element can only be simultaneously heated in parallel, and the third heating element is selectively enabled to participate in simultaneous heating or not, so that it is beneficial to flexibly control differential heating of different sections of an aerosol generating article.

### BRIEF DESCRIPTION OF THE DRAWINGS

One or more embodiments are exemplarily described with reference to pictures in accompanying drawings corresponding to the embodiments, and the exemplary descriptions do not constitute a limitation on the embodiments. Elements in the accompanying drawings that have same reference numerals are represented as similar elements, and unless otherwise particularly stated, the figures in the accompanying drawings do not constitute a scale limitation.

FIG. 1 is a schematic diagram of an electronic atomization device according to an embodiment.

FIG. 2 is a schematic structural diagram of a heater in FIG. 1 from a perspective.

FIG. 3 is a schematic structural diagram of a heater in FIG. 2 from another perspective.

FIG. 4 is a schematic exploded view of the heater in FIG. 2 from a perspective.

FIG. 5 is a schematic diagram of connecting the heater of FIG. 2 to a battery core in an embodiment.

FIG. 6 is a schematic diagram of guiding a current on the heater of FIG. 2 in an embodiment.

FIG. 7 is a schematic diagram of guiding a current on the heater of FIG. 2 in another embodiment.

FIG. 8 is a schematic diagram of guiding a current on the heater of FIG. 2 in another embodiment.

FIG. 9 is a schematic structural diagram of a heater according to another embodiment from a perspective.

FIG. 10 is a schematic diagram of the heater in FIG. 9 unfolded along a circumferential direction.

FIG. 11 is a schematic structural diagram of a heater according to another embodiment from a perspective.

FIG. 12 is a schematic diagram of the heater in FIG. 11 unfolded along a circumferential direction.

FIG. 13 is a temperature curve of a heater in an embodiment during heating.

### DETAILED DESCRIPTION

To facilitate understanding of this application, this application is described in more detail below with reference to accompanying drawings and specific implementations.

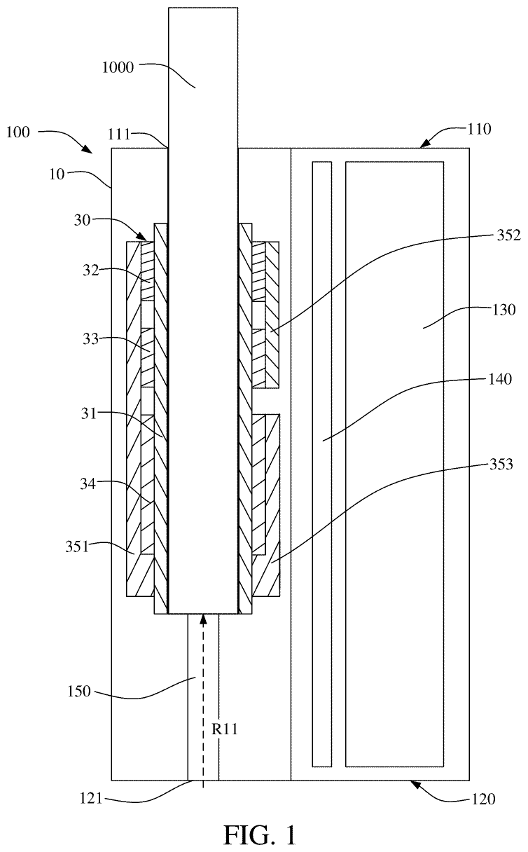

An embodiment of this application provides an aerosol generating device 100 that heats but not burns an aerosol generating article 1000, for example, a cigarette, to volatilize or release at least one component of the aerosol generating article 1000 to form an aerosol for inhalation, for example, as shown in FIG. 1.

In an optional implementation, the aerosol generating article 1000 utilizes a tobacco-containing material that releases a volatile compound from a substrate during heating, or may be a non-tobacco material that can be heated and then suitable for electric heating to produce smoke. The aerosol generating article 1000 is preferably made of a solid substrate. The solid substrate may include one or more of powders, particles, fragment strips, stripes, or flakes of one or more of vanilla leaves, tobacco leaves, homogeneous tobacco, and expanded tobacco. Alternatively, the solid substrate may include additional tobacco or non-tobacco volatile aroma compounds to be released when the substrate is heated.

In addition, as shown in FIG. 1, after the aerosol generating article 1000 is received in an aerosol generating device 100, a portion of the aerosol generating article is exposed outside the aerosol generating device 100, such as a filter tip, which is beneficial for users to smoke.

A configuration of an aerosol generating device according to an embodiment of this application may be shown in FIG. 1. An overall shape of the device is generally constructed to a flat cylinder shape, and an external member of the aerosol generating device 100 includes:
a housing 10, having a hollow construction inside, which forms an assembly space for necessary functional components such as an electronic device and a heating device. The housing 10 has a proximal end 110 and a distal end 120 that are opposite to each other along a length direction, where
the proximal end 110 is provided with an opening 111. The aerosol generating article 1000 may be received in the housing 10 through the opening 111 to be heated or removed from the housing 10.

The distal end 120 is provided with an air inlet hole 121. The air inlet hole 121 is configured to allow external air to enter the housing 10 during smoking.

As shown in FIG. 1, the aerosol generating device 100 further includes:
a chamber, configured to accommodate or receive the aerosol generating article 1000. During use, the aerosol generating article 1000 may be removably received in the chamber through the opening 111. In some embodiments, a length of the aerosol generating article 1000 that is surrounded and heated by a heater 30 is greater than 30 mm.

As shown in FIG. 1, the aerosol generating device 100 further includes:
an air channel 150, located between the chamber and the air inlet 121; where during use, the air channel 150 provides a channel path from the air inlet 121 into the chamber/aerosol generating article 1000, as shown by an arrow R11 in FIG. 1.

As shown in FIG. 1, the aerosol generating device 100 further includes:
a battery core 130 for supplying power, where preferably, the battery core 130 is a rechargeable direct current battery core 130, and can be charged after being connected to an external power source; and
a circuit board 140, for example, a PCB board, provided with a circuit or an MCU controller, where the circuit may be an integrated circuit.

As shown in FIG. 1, the aerosol generating device 100 further includes:
a heater 30, at least partially surrounding and defining the chamber. When the aerosol generating article 1000 is received in the housing 10, the heater 30 at least partially surrounds or encloses the aerosol generating article 1000, and performs heating from a periphery of the aerosol generating article 1000. Moreover, the aerosol generating article 1000 is at least partially accommodated and retained in the heater 30 when received in the housing 10.

In some implementations, a length of the heater 30 is in a range of 20-50 mm; and/or the heater 30 has an inner diameter in a range of 5.0-10.0 mm.

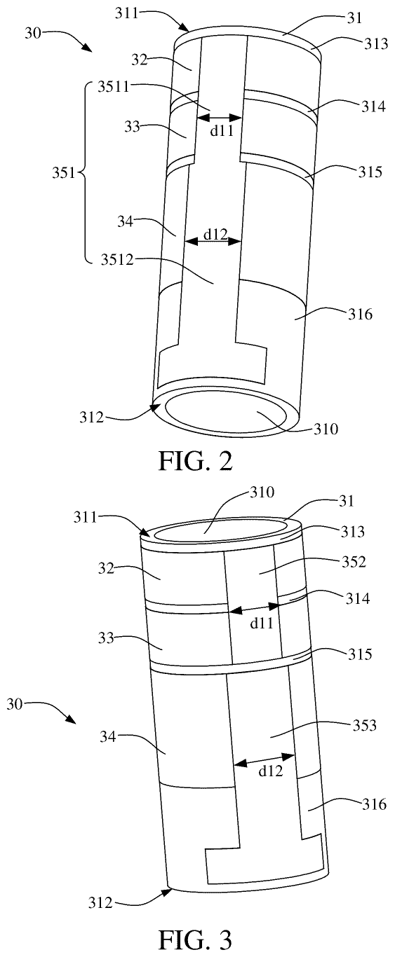

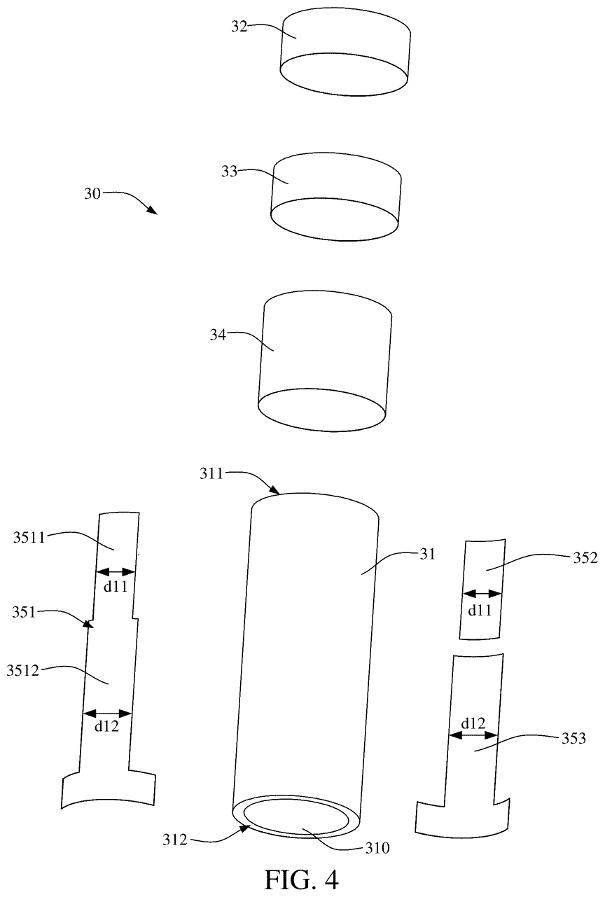

Referring to FIG. 2 to FIG. 4, the heater 30 is configured in a substantially longitudinal tubular shape, and includes:
a tubular substrate 31, where a material of the substrate 31 is an infrared-transmissive material such as a quartz tube, a glass tube, a ceramic tube; during use, the substrate 31 is at least partially defined for accommodating and retaining the aerosol generating article 1000; and
a first heating element 32, a second heating element 33, and a third heating element 34 formed or arranged on the substrate 31. In the embodiment, the first heating element 32 and/or the second heating element 33 and/or the third heating element 34 is formed on an outer surface of the substrate 31 through deposition, spraying, wrapping, or the like.

The first heating element 32 and/or the second heating element 33 and/or the third heating element 34 are arranged in sequence and spaced apart from each other. In addition, the first heating element 32 and/or the second heating element 33 and/or the third heating element 34 are substantially in an annular shape surrounding the substrate 31. In addition, the first heating element 32 and/or the second heating element 33 and/or the third heating element 34 are closed in a circumferential direction.

In some specific implementations, the substrate 31 has a wall thickness of about 0.05-1 mm; and the substrate 31 has an inner diameter of about 5.0-8.0 mm; and the substrate 31 has a length of about 30-60 mm.

Alternatively, in some other embodiments, the first heating element 32 and/or the second heating element 33 and/or the third heating element 34 are formed on an inner surface of the substrate 31.

In some embodiments, the first heating element 32 and/or the second heating element 33 and/or the third heating element 34 are coatings or thin layers formed on the substrate 31 through deposition, spraying, or the like. Alternatively, in some other embodiments, the first heating element 32 and/or the second heating element 33 and/or the third heating element 34 are thin films wrapped or bonded to the substrate 31.

In some embodiments, the first heating element 32 and/or the second heating element 33 and/or the third heating element 34 are resistive heating elements, which perform heating through resistive Joule heating. For example, the first heating element 32 and/or the second heating element 33 and/or the third heating element 34 may be a resistance heating coating or resistance heating track wrapped or deposited on the substrate 31; or the first heating element 32 and/or the second heating element 33 and/or the third heating element 34 may be a wrapped or coiled resistive heating mesh. The material of the first heating element 32 and/or the second heating element 33 and/or the third heating element 34 are made of metal material, metal alloy, graphite, carbon, conductive ceramic, or other composite materials of a ceramic material and a metal material with appropriate impedance. A suitable metal or alloy material includes at least one of nickel, cobalt, zirconium, titanium, nickel alloy, cobalt alloy, zirconium alloy, titanium alloy, nickel-chromium alloy, nickel-iron alloy, iron-chromium alloy, iron-chromium-aluminum alloy, iron-manganese-aluminum based alloy, or stainless steel. In the embodiment, the substrate 31 receives heat from the first heating element 32 and/or the second heating element 33 and/or the third heating element 34, and then heats the aerosol generating article 1000. Correspondingly, in the embodiment, the substrate 31 may include a tube made of a metal or alloy that is easily heat-conducting, for example, an aluminum alloy tube or a stainless steel tube.

In some embodiments, the first heating element 32 and/or the second heating element 33 and/or the third heating element 34 are electrically induced infrared heating elements. A direct current voltage is directly supplied to the first heating element 32 and/or the second heating element 33 and/or the third heating element 34, so that the first heating element 32 and/or the second heating element 33 and/or the third heating element 34 can radiate infrared rays under voltage drive to perform heating. In the embodiment, the substrate 31 includes at least one of infrared-transmissive quartz, acryl, and the like.

In some implementations, the first heating element 32 and/or the second heating element 33 and/or the third heating element 34 may be coatings that include ceramic-based materials such as zirconium, or are prepared from Fe—Mn—Cu-based, tungsten-based, or transition metal materials and oxides thereof.

In some implementations, the first heating element 32 and/or the second heating element 33 and/or the third heating element 34 are composed of oxides of at least one metal element such as Mg, Al, Ti, Zr, Mn, Fe, Co, Ni, Cu, Cr, and Zn. These metal oxides can radiate far infrared rays with a heating effect when heated to an appropriate temperature. A thickness of the first heating element 32 and/or the second heating element 33 and/or the third heating element 34 is preferably controlled to be in a range of 30 μm to 50 μm. Through formation on the surface of the tubular substrate 31, the oxides of the above metal elements may be sprayed onto the outer surface of the tubular substrate 31 through atmospheric plasma spraying and then solidified.

In the embodiments shown in FIG. 2 to FIG. 4, the first heating element 32 and the second heating element 33 have the same length dimension, and a length dimension of the third heating element 34 is greater than the length dimensions of the first heating element 32 and the second heating element 33. In some specific embodiments, the length dimensions of the first heating element 32 and the second heating element 33 are in a range of 2.5-5.0 mm; and the length dimension of the third heating element 34 is in a range of 5.0-10 mm. The length dimension of the third heating element 34 is equal to a sum of the length dimensions of the first heating element 32 and the second heating element 33.

Alternatively, in some other embodiments, the first heating element 32, the second heating element 33, and the third heating element 34 have substantially the same length. For example, in a specific embodiment, the length dimensions of the first heating element 32, the second heating element 33, and the third heating element 34 are all in a range of 3-8 mm.

Alternatively, in some other variant embodiments, a length of any one of the first heating element 32 and/or the second heating element 33 and/or the third heating element 34 is different from those of the other two. Alternatively, in some other variations of the embodiment, the first heating element 32, the second heating element 33, and the third heating element 34 each have a length different from the other two.

Alternatively, in some other embodiments, extension lengths of the first heating element 32, the second heating element 33, and the third heating element 34 gradually change along an axial direction of the heater 30. For example, in some specific embodiments, the extension lengths of the first heating element 32, the second heating element 33, and the third heating element 34 gradually or sequentially increase, or the extension lengths of the first heating element 32, the second heating element 33, and the third heating element 34 gradually or sequentially decrease.

Alternatively, in some other embodiments, a length dimension of the second heating element 33 is less than the length dimension of any one of the first heating element 32 and the third heating element 34. Alternatively, in some other embodiments, the length dimension of the second heating element 33 is greater than the length dimension of any one of the first heating element 32 and the third heating element 34.

Alternatively, in some other embodiments, the heater 30 may further include three heating elements, that is, the first heating element 32, the second heating element 33, and the third heating element 34. Alternatively, in some other embodiments, the heater 30 further includes more heating elements, for example, four, five, six, or more heating elements arranged at intervals in sequence along the axial direction of the substrate 31.

Alternatively, as shown in FIG. 2 and FIG. 3, the heater 30 further includes:
a first end 311 and a second end 312 facing away from each other along the axial direction;
an infrared-transmissive substrate 31, constructed into a tubular shape, where during implementation, two ends of the substrate 31 in the length direction respectively define the first end 311 and the second end 312 of the heater 30; an inner cavity 310 of the substrate 31 defines at least a chamber for receiving the aerosol generating article 1000; and
the first heating element 32, the second heating element 33, and the third heating element 34 are formed on the substrate 31 and arranged in sequence along the axial direction of the substrate 31. Certainly, the first heating element 32, the second heating element 33, and the third heating element 34 are spaced apart from each other.

As shown in FIG. 2 and FIG. 3, the first heating element 32 is arranged close to the first end 311, the third heating element 34 is arranged close to the second end 312, and the second heating element 33 is located between the first heating element 32 and the third heating element 34.

In addition, a surface of the substrate 31 is further defined with:
an exposed section 313, located between the first end 311 and the first heating element 32;
an exposed section 314, located between the first heating element 32 and the second heating element 33, to separate the first heating element 32 from the second heating element 33;
an exposed section 315, located between the second heating element 33 and the third heating element 34, to separate the second heating element 33 from the third heating element 34; and
an exposed section 316, located between the third heating element 34 and the second end 312.

In some embodiments, along the axial direction of the substrate 31, the exposed section 313, the exposed section 314, and the exposed section 315 have substantially the same dimension. For example, in some specific embodiments, the exposed section 313, the exposed section 314, and the exposed section 315 have a length of approximately 0.5-3 mm.

In some embodiments, a length dimension of the exposed section 316 along the axial direction of the substrate 31 is greater than length dimensions of the exposed section 313 and/or the exposed section 314 and/or the exposed section 315. For example, in some specific embodiments, the length dimension of the exposed section 316 along the axial direction of the substrate 31 is in a range of 3-5 mm.

In some embodiments, a temperature measurement mark is provided on each of the first heating element 32, the second heating element 33, and the third heating element 34, to provide a position indication for mounting and attachment of a temperature sensor. During manufacturing, the temperature sensor is mounted or welded onto the temperature measurement mark to accurately sense a temperature of each of the first heating element 32, the second heating element 33, and the third heating element 34.

In some embodiments, the first heating element 32, the second heating element 33, and the third heating element 34 are made of the same material, so as to have the same infrared radiation wavelength or infrared radiation efficiency when heating different sections of the aerosol generating article 1000.

Alternatively, in some other variant embodiments, one of the first heating element 32, the second heating element 33, and the third heating element 34 is made of a different material from the other two, and one of the first heating element 32, the second heating element 33, and the third heating element 34 has an infrared emission spectrum with a different peak wavelength (WLP, a wavelength corresponding to a maximum radiation power) from the other two, which may be respectively suitable for the optimal absorption wavelength range of different organic components in the aerosol generating article 1000. Alternatively, in some other embodiments, the first heating element 32, the second heating element 33, and the third heating element 34 are all made of different materials, and any two of the first heating element 32, the second heating element 33, and the third heating element 34 have different infrared emission spectra and/or WLPs.

As shown in FIG. 1 to FIG. 3, the heater 30 further includes:
a first electrode 351, which has an elongated or longitudinal shape; the first electrode 351 basically extends from the first end 311 to the second end 312; the first electrode 351 spans the first heating element 32, the second heating element 33, and the third heating element 34; or the first electrode 351 extends from an end portion of the first heating element 32 close to the first end 311 to the third heating element 34; and the first electrode 351 is simultaneously electrically connected to the first heating element 32, the second heating element 33, and the third heating element 34;
a second electrode 352, which has an elongated or longitudinal shape; the second electrode 352 extends from the first heating element 32 onto the second heating element 33 along the longitudinal direction; the second electrode 352 is electrically connected to the first heating element 32 and the second heating element 33; and the second electrode 352 is radially opposite to the first electrode 351 along a radial direction of the heater 30; and
a third electrode 353, which has an elongated or longitudinal shape; the third electrode 353 extends on the third heating element 34 along the longitudinal direction; the third electrode 353 is electrically connected to the third heating element 34; and the third electrode 353 is radially opposite to the first electrode 351 along the radial direction of the heater 30.

In some embodiments, the foregoing first electrode 351 and/or second electrode 352 and/or third electrode 353 are made of metal or alloy with low resistivity, such as silver, gold, palladium, platinum, copper, nickel, molybdenum, tungsten, niobium, or alloys thereof. The foregoing first electrode 351 and/or second electrode 352 and/or third electrode 353 is formed through spraying, printing, or the like. Alternatively, in some other embodiments, the first electrode 351 and/or the second electrode 352 and/or the third electrode 353 are sheets of metal or alloy.

In some implementations, the second electrode 352 is only bonded to the first heating element 32 and the second heating element 33, and avoids the third heating element 34; and the third electrode 353 is only bonded to the heating element 34, and avoids the first heating element 32 and the second heating element 33.

In embodiments shown in FIG. 2 to FIG. 4, the first electrode 351, the second electrode 352, and the third electrode 353 respectively have different width dimensions. Specifically,
the first electrode 351 includes a first width portion 3511 and a second width portion 3512 that are arranged along the longitudinal direction. The first width portion 3511 is bonded to or spans the first heating element 32 and the second heating element 33; the second width portion 3512 is bonded to the third heating element 34; and a width dimension d11 of the first width portion 3511 is less than a width dimension d12 of the second width portion 3512.

The second electrode 352 has a same width dimension d11 as the first width portion 3511.

The third electrode 353 has a same width dimension d12 as the second width portion 3512; and a width dimension 12 of the third electrode 353 is greater than the width dimension d11 of the second electrode 352.

In some specific embodiments, the width dimension d11 is in a range of 2.5-3.5 mm; and the width dimension 12 is approximately 3.5-4.5 mm.

In some embodiments, the first electrode 351 and/or the second electrode 352 and/or the third electrode 353 are each directly connected to the circuit board 140 through a welding lead or the like, and then configured by the circuit board 140 to connect the first electrode 351 and/or the second electrode 352 and/or the third electrode 353 to the battery core 130, so as to selectively guide a current in a circumferential direction of the first heating element 32, the second heating element 33, and the third heating element 34.

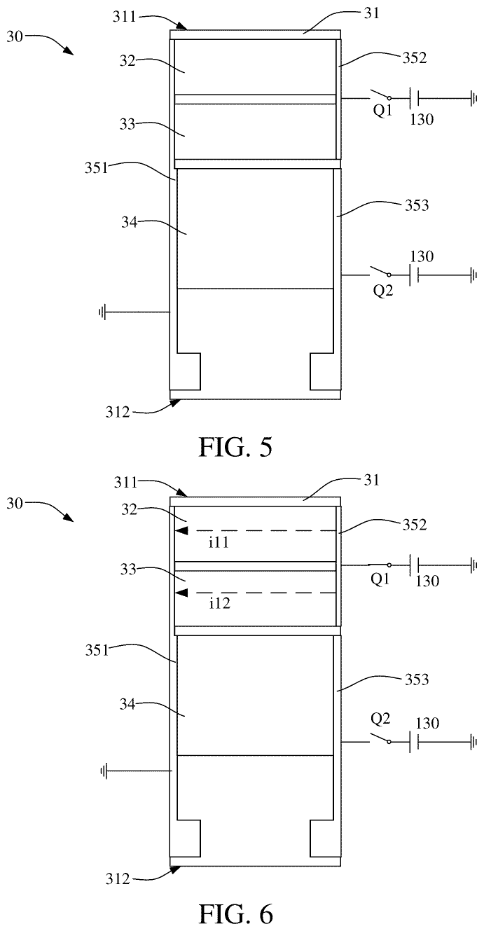

Alternatively, FIG. 5 is a schematic diagram of a circuit on a circuit board 140 electrically connects a heater 30 to a battery core 130 in an embodiment. As shown in FIG. 5, the second electrode 352 is electrically connected to a positive electrode of the battery core 130 through a switch transistor Q1, and the third electrode 353 is electrically connected to the positive electrode of the battery core 130 through a switch transistor Q2; and the first electrode 351 is grounded and then is connected to a negative electrode of the battery core 130. Therefore, during use, on the one hand, the circuit may selectively enable only one of the switch transistor Q1 and the switch transistor Q2 to be turned on or both to be simultaneously turned on, so that the first heating element 32, the second heating element 33, and the third heating element 34 are simultaneously heated in parallel, or only the first heating element 32 and the second heating element 33 are selectively enabled to be simultaneously heated in parallel, or only the third heating element 34 is enabled to be heated separately.

For example, FIG. 6 shows a schematic diagram of guiding a current on a heater 30 in an embodiment. According to FIG. 6, the circuit may form a current i11 flowing through the first heating element 32 in the circumferential direction and a current i12 flowing through the second heating element 33 by turning on the switch transistor Q1 and turning off the switch transistor Q2, so that only the first heating element 32 and the second heating element 33 are simultaneously heated in parallel. As shown in FIG. 6, when the switch transistor Q2 is turned off, the third heating element 34 has no current therein, or in this case, the third heating element 34 is not heated.

Similarly, the circuit may further adopt a manner of turning off the switch transistor Q1 and turning on the switch transistor Q2 to form a current flowing through the third heating element 34 in the circumferential direction, so that the third heating element 34 is heated separately, and the first heating element 32 and the second heating element 33 are not heated.

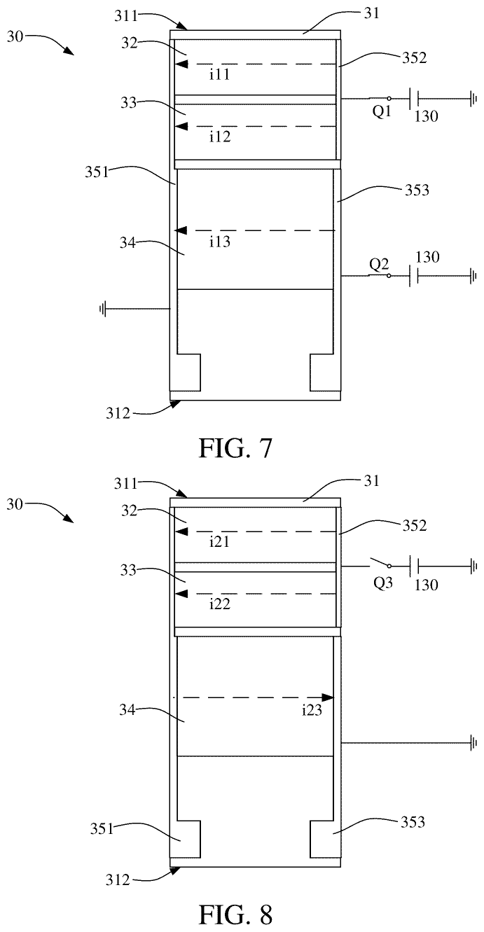

For another example, FIG. 7 shows a schematic diagram of guiding a current on a heater 30 in another embodiment. As shown in FIG. 7, the circuit may simultaneously form a current i11 flowing through a first heating element 32, a current i12 flowing through a second heating element 33, and a current i13 flowing through a third heating element 34 in a circumferential direction by turning on both the switch transistor Q1 and the switch transistor Q2, so that the first heating element 32, the second heating element 33, and the third heating element 34 are simultaneously heated in parallel.

As shown in FIG. 7, when the switch transistor Q1 and the switch transistor Q2 are both turned on to form simultaneous heating in parallel, the current i11 of the first heating element 32 and the current i12 of the second heating element 33 are substantially equal, and are substantially equal to half of the current i13 of the third heating element 34.

During use, the circuit may selectively adopt the manner shown in FIG. 6 or FIG. 7 during different time phases, so as to differentially heat different sections of the aerosol generating article 1000. For example, in a specific embodiment, that the circuit controls the heating process of different sections of the aerosol generating article 1000 includes the following steps.

S100: During a first time phase, turn on a switch transistor Q1 and turn off a switch transistor Q2 in the manner in FIG. 6, so that only a first heating element 32 and a second heating element 33 are simultaneously heated in parallel, where during this phase, an aerosol generating article 1000 is heated simultaneously by a first section surrounded by the first heating element 32 and a second section surrounded by the second heating element 33, so that the first section and the second section of the aerosol generating article 1000 close to a filter tip rapidly generate an aerosol for a user to inhale.

S200: During a second time phase, simultaneously turn on the switch transistor Q1 and the switch transistor Q2 in the manner in FIG. 7, so that the first heating element 32, the second heating element 33, and a third heating element 34 are simultaneously heated in parallel, where during this phase, the aerosol generating article 1000 is heated simultaneously by the first section surrounded by the first heating element 32, the second section surrounded by the second heating element 33, and a third section surrounded by the third heating element 34, so that a large amount of aerosol is generated as a whole and provided to the user.

Moreover, in the embodiments shown in FIG. 5 to FIG. 7, through an arrangement manner of a circuit, the first heating element 32 and the second heating element 33 can only be heated in parallel simultaneously. The first heating element 32 and the second heating element 33 cannot start heating independently of each other.

In some other variant embodiments, for example, FIG. 8 shows a schematic diagram of a circuit connecting a heater 30 to a battery core 130 in yet another variant embodiment. In the embodiment shown in FIG. 8, the circuit connects the second electrode 352 to a positive electrode of the battery core 130, and connects the third electrode 353 to the negative electrode of the battery core 130 through ground, and the first electrode 351 is not connected to the circuit. Further, as shown in FIG. 8, the first heating element 32 and the second heating element 33 are connected in parallel and then connected in series with the third heating element 34 through the first electrode 351, thereby forming a current i21 flowing from the second electrode 352 to the first electrode 351 along a circumferential direction of the first heating element 32, a current i22 flowing from the second electrode 352 to the first electrode 351 along a circumferential direction of the second heating element 33, and a current i23 flowing from the first electrode 351 to the third electrode 353 along a circumferential direction of the third heating element 34 in FIG. 8.

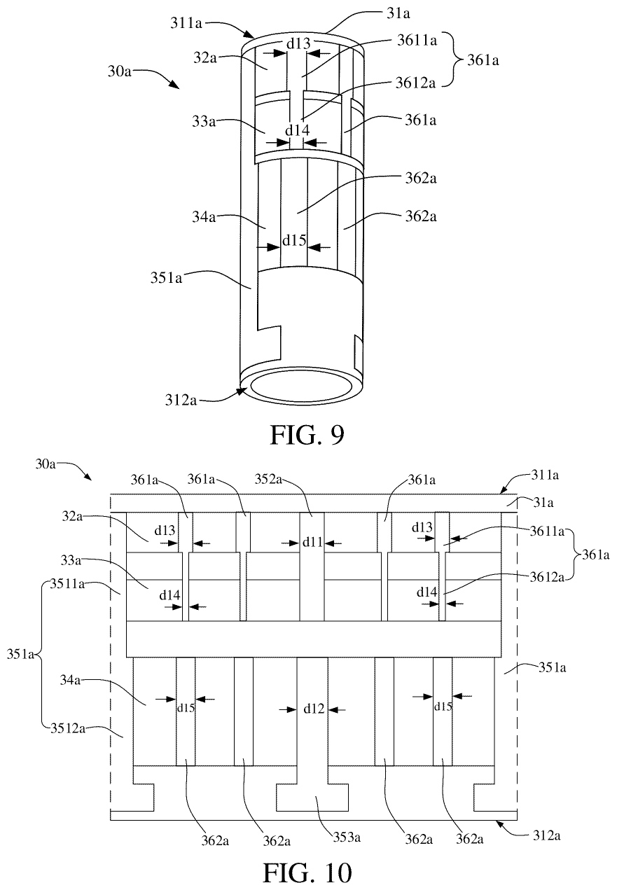

FIG. 9 and FIG. 10 shows a schematic diagram of a heater 30a according to still another embodiment. In the embodiment, the heater 30 includes:
a tubular substrate 31a, which has a first end 311a and a second end 312a facing away from each other along a longitudinal direction;
a first heating element 32a, a second heating element 33a, and a third heating element 34a spaced apart and arranged on the substrate 31a in sequence along the longitudinal direction;
a first electrode 351a, extending from the first heating element 32a to the third heating element 34a;
a second electrode 352a, extending from the first heating element 32a to the second heating element 33a, and arranged opposite to the first electrode 351a along a radial direction of the heater 30a; and
a third electrode 353a, bonded to the third heating element 34a, and arranged opposite to the first electrode 351a along the radial direction of the heater 30a, where the second electrode 352a and the third electrode 353a are substantially aligned along the longitudinal direction of the heater 30a.

The first electrode 351a includes a first width portion 3511a and a second width portion 3512a arranged along the longitudinal direction. The first width portion 3511a is bonded to or spans the first heating element 32a and the second heating element 33a. The second width portion 3512a is bonded to the third heating element 34a. A width dimension d11 of the first width portion 3511a is less than a width dimension d12 of the second width portion 3512a. The second electrode 352a has a same width dimension d11 as the first width portion 3511a. The third electrode 353a has a same width dimension d12 as the second width portion 3512a. A width dimension 12 of the third electrode 353a is greater than the width dimension d11 of the second electrode 352a.

Further, according to embodiments shown in FIG. 9 and FIG. 10, the heater 30a further includes:
one or more first empty electrodes 361a, spaced apart and arranged around the first heating element 32a and the second heating element 33a along a circumferential direction, where the first empty electrode 361a extends from the first heating element 32a onto the second heating element 33a; and the first empty electrode 361a avoids the third heating element 34a; and
one or more second empty electrodes 362a, spaced apart and arranged around the third heating element 34a along the circumferential direction, where the second empty electrode 362a avoids the first heating element 32a and the second heating element 33a.

In this embodiment, the first empty electrode 361a and the second empty electrode 362a are not connected to a circuit during use. The first empty electrode 361a and the second empty electrode 362a are made of metal or an alloy material with low resistivity. When a current is guided on the first heating element 32a and the second heating element 33a through the first electrode 351a and the second electrode 352a, the first empty electrode 361a can serve as a low-resistivity material to reduce resistance values of the first heating element 32a and the second heating element 33a. Moreover, when a current is guided on the third heating element 34a through the first electrode 351a and the third electrode 353a, the second empty electrode 362a can serve as a low-resistivity material to reduce a resistance value of the third heating element 34a.

As shown in FIG. 9 and FIG. 10, the first empty electrode 361a includes a third width portion 3611a and a fourth width portion 3612a arranged in sequence along the longitudinal direction; and the third width portion 3611a is bonded to the first heating element 32a, and the fourth width portion 3612a is bonded to the second heating element 33a.

In the embodiments shown in FIG. 9 and FIG. 10, a width dimension d13 of the third width portion 3611a is greater than a width dimension d14 of the fourth width portion 3612a. Moreover, a width dimension d15 of the second empty electrode 362a is greater than the width dimension d13 of the third width portion 3611a. Further, in the embodiment, the second empty electrode 362a has a larger width dimension d15, so that when the current is guided in the circumferential direction, the resistance value of the third heating element 34a is reduced at a greater rate.

In the embodiments shown in FIG. 9 and FIG. 10, the width dimension d15 of the second empty electrode 362a is less than the width dimension d11 of the second electrode 352a.

In some specific embodiments, the width dimension d11 of the second electrode 352a is 3.0 mm; the width dimension d12 of the third electrode 353a is 3.7 mm; the width dimension d13 of the third width portion 3611a of the first empty electrode 361a is 1.48 mm; the width dimension d14 of the fourth width portion 3612a of the first empty electrode 361a is 1.0 mm; and the width dimension d15 of the second empty electrode 362a is 2.0 mm.

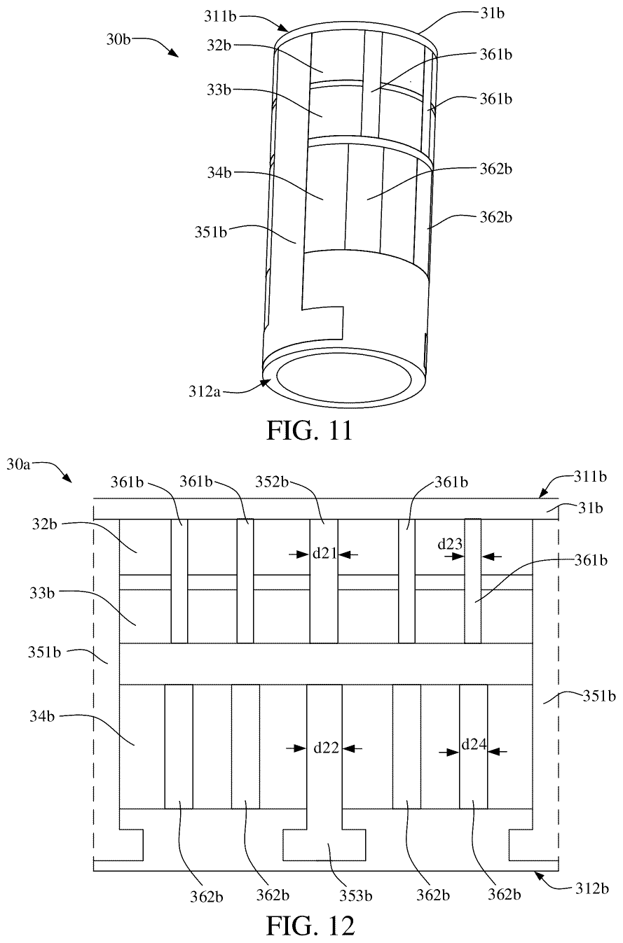

Alternatively, FIG. 11 and FIG. 12 are schematic diagrams showing a heater 30b according to still another embodiment. In the embodiment, the heater 30b includes:
a tubular substrate 31b, which has a first end 311b and a second end 312b facing away from each other along a longitudinal direction;
a first heating element 32b, a second heating element 33b, and a third heating element 34b spaced apart and arranged on the substrate 31b in sequence along the longitudinal direction;
a first electrode 351b, extending from the first heating element 32b to the third heating element 34b;
a second electrode 352b, extending from the first heating element 32b to the second heating element 33b, and arranged opposite to the first electrode 351b along a radial direction of the heater 30b; and
a third electrode 353b, bonded to the third heating element 34b, and arranged opposite to the first electrode 351b along the radial direction of the heater 30b, where the second electrode 352b and the third electrode 353b are substantially aligned along the longitudinal direction of the heater 30b.

Further, according to embodiments shown in FIG. 11 and FIG. 12, the heater 30b further includes:
one or more first empty electrodes 361b, spaced apart and arranged around the first heating element 32b and the second heating element 33b along a circumferential direction, where the first empty electrode 361b extends from the first heating element 32b onto the second heating element 33b; and the first empty electrode 361b avoids the third heating element 34b; and
one or more second empty electrodes 362b, spaced apart and arranged around the third heating element 34b along the circumferential direction, where the second empty electrode 362b avoids the first heating element 32b and the second heating element 33b.

In this embodiment, the first empty electrode 361b and the second empty electrode 362b are not connected to a circuit during use. The first empty electrode 361b and the second empty electrode 362b are made of metal or an alloy material with low resistivity. When a current is guided on the first heating element 32b and the second heating element 33b through the first electrode 351b and the second electrode 352b, the first empty electrode 361b can serve as a low-resistivity material to reduce resistance values of the first heating element 32b and the second heating element 33b. Moreover, when a current is guided on the third heating element 34a through the first electrode 351b and the third electrode 353b, the second empty electrode 362b can serve as a low-resistivity material to reduce a resistance value of the third heating element 34b.

In embodiments shown in FIG. 11 and FIG. 12, the first electrode 351b, the second electrode 352b, and the third electrode 353b have substantially constant widths. Moreover, the first empty electrode 361b and the second empty electrode 362b also have constant widths.

As shown in FIG. 11 and FIG. 12, the second electrode 352b has a width dimension d21. The first electrode 351b and the third electrode 353b have the same width dimension d22. The first empty electrode 361b has a width dimension d23. The second empty electrode 362b has a width dimension d24.

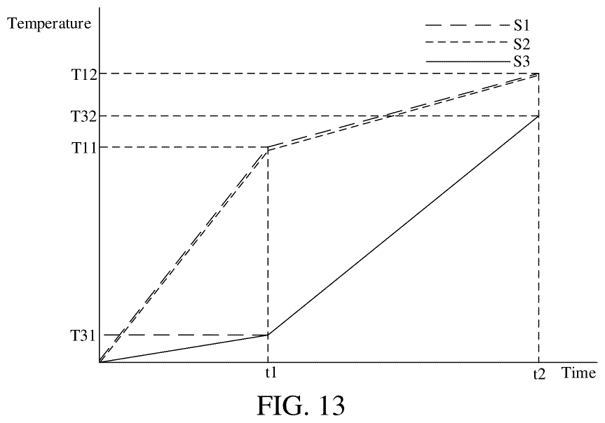

FIG. 13 shows heating curves of different sections of an aerosol generating article 1000 through the heater 30b shown in FIG. 11 in an embodiment, where a curve S1 is a temperature curve of heating by the first heating element 32b, a curve S2 is a temperature curve of heating by the second heating element 33b, and a curve S3 is a temperature curve of heating by the third heating element 34b. According to FIG. 13, the heating process includes the following steps.

S100b: During a first time phase (a period of time 0-t1), turn on a switch transistor Q1 and turn off a switch transistor Q2 in a circuit connection manner of FIG. 6, and connect a first electrode 351b and a second electrode 352b to a battery core 130, so that the first heating element 32b and the second heating element 33b simultaneously start heating in parallel, and then are heated from a room temperature to a first target temperature T11, where during this first time phase, the third heating element 34b does not generate heat and can only receive a small amount of heat conducted from the substrate 31b through heat transfer, and is heated from the room temperature to a second target temperature T31; and obviously, during the first time phase, a heating rate of the third heating element 34b generated through thermal conduction is lower than that of the first heating element 32b and the second heating element 33b.

S200b: During a second time phase (a period of time t1-t2), turn on both the switch transistor Q1 and the switch transistor Q2 in a circuit connection manner of FIG. 7, so that the first heating element 32b, the second heating element 33b, and the third heating element 34b simultaneously start heating in parallel.

Then during the second time phase, the first heating element 32b and the second heating element 33b are enabled to continue to be heated from the first target temperature T11 to a third target temperature T12; and during the second time phase, the third heating element 34b is heated from the second target temperature T31 to a fourth target temperature T32.

Moreover, during the second time phase, due to the second empty electrode 362b on the third heating element 34b and a larger length dimension, the third heating element 34b has a smaller resistance value and therefore has greater power during heating in parallel, so that during the second time phase, the third heating element 34b is heated at a heating rate greater than that of the first heating element 32b and the second heating element 33b; and in this way, during the second time phase, the third heating element 34b heats up faster.

In some embodiments, a duration of the first time phase is 30-120 s; and a duration of the second time phase is 90-180 s.

In some embodiments, during the first time phase, the first heating element 32b and the second heating element 33b are heated from the room temperature to the first target temperature T11 of approximately 200-350 °C; and during the first time phase, the third heating element 34b receives heat from the second heating element 33b through heat conduction and is heated to the second target temperature T31 of approximately 30-100 °C. During the second time phase, the first heating element 32b and the second heating element 33b are enabled to continue to be heated to the third target temperature T12 of approximately 250-400 °C; and during the second time phase, the third heating element 34b is enabled to continue to be heated to the fourth target temperature T32 of approximately 250-400 °C. In some embodiments, the third target temperature T12 and the fourth target temperature T32 may tend to be the same or close; and alternatively, in some other embodiments, the fourth target temperature T32 may further be made lower than the third target temperature T12, as shown in FIG. 13.

In an embodiment shown in FIG. 13, through an arrangement manner of a circuit, the first heating element 32b and the second heating element 33b can only be heated in parallel simultaneously. Moreover, lengths of the first heating element 32b and the second heating element 33b are the same, and during heating, temperature changes of the first heating element 32b and the second heating element 33b are basically the same.

It should be noted that the preferred embodiments of this application are provided in the specification and the accompanying drawings of this application, but are not limited to the embodiments described in this specification. Further, a person of ordinary skill in the art may make improvements or modifications according to the foregoing descriptions, and all of the improvements and modifications shall fall within the protection scope of the appended claims of this application.

1. An aerosol generating device, configured to heat an aerosol generating article to generate an aerosol, comprising:
a battery core, configured to supply power; and
a heater, configured to heat the aerosol generating article, wherein the heater comprises at least:
a first heating element, a second heating element, and a third heating element arranged in sequence along a longitudinal direction; and
a first electrode, a second electrode, and a third electrode, operably electrically connected to the battery core, to guide a current on the heater, wherein
the first heating element and the second heating element are electrically connected in parallel between the first electrode and the second electrode; and the third heating element is electrically connected between the first electrode and the third electrode.

2. The aerosol generating device according to claim 1, further comprising:
a circuit, configured to:
electrically connect, during a first time phase, one of a positive electrode and a negative electrode of the battery core to the first electrode, and electrically connect the other to the second electrode, so that the first heating element and the second heating element are simultaneously heated in parallel; and
electrically connect, during a second time phase, one of a positive electrode and a negative electrode of the battery core to the first electrode, and electrically connect the other to the second electrode and the third electrode simultaneously, so that the first heating element, the second heating element, and the third heating element are simultaneously heated in parallel.

3. The aerosol generating device according to claim 1, wherein the first heating element and the second heating element are only enabled to simultaneously start heating in parallel.

4. The aerosol generating device according to claim 1, wherein the first heating element and the second heating element are not allowed to start heating independently of each other.

5. The aerosol generating device according to claim 2, wherein during the second time phase, when the first heating element, the second heating element, and the third heating element are simultaneously heated in parallel, a power of the third heating element is greater than a power of the first heating element and a power of the second heating element.

6. The aerosol generating device according to claim 1, wherein along the longitudinal direction of the heater, the first heating element has a first length dimension, the second heating element has a second length dimension, and the third heating element has a third length dimension; and
the first length dimension and/or the second length dimension is less than the third length dimension.

7. The aerosol generating device according to claim 1, wherein the first electrode extends from the first heating element to the third heating element along the longitudinal direction of the heater; and/or
the second electrode extends from the first heating element to the second heating element along the longitudinal direction of the heater; and/or
the third electrode is arranged to extend on the third heating element along the longitudinal direction of the heater.

8. The aerosol generating device according to claim 7, wherein the first electrode comprises a first width portion and a second width portion arranged in sequence along the longitudinal direction, and a width dimension of the first width portion is less than a width dimension of the second width portion;
the first width portion extends from the first heating element to the second heating element; and
the second width portion is bonded to the third heating element.

9. The aerosol generating device according to claim 7, wherein a width dimension of the second electrode is less than a width dimension of the third electrode.

10. The aerosol generating device according to claim 1, further comprising:
one or more first empty electrodes, arranged to extend from the first heating element to the second heating element, to reduce resistance of the first heating element and the second heating element, wherein the first empty electrode is not electrically connected to the battery core.

11. The aerosol generating device according to claim 10, wherein the first empty electrode comprises a third width portion and a fourth width portion arranged in sequence along the longitudinal direction; and
the third width portion is bonded to the first heating element, and the fourth width portion is bonded to the second heating element; and the third width portion has a width dimension different from that of the fourth width portion.

12. The aerosol generating device according to claim 1, further comprising:
one or more second empty electrodes, arranged on the third heating element at intervals along a circumferential direction, to reduce resistance of the third heating element, wherein the second empty electrode is not electrically connected to the battery core.

13. The aerosol generating device according to claim 2, wherein the circuit is configured to:
heat, during the first time phase, the first heating element and the second heating element from a room temperature to a first target temperature, and enable the third heating element to be heated to a second target temperature by receiving heat from the second heating element; and
heat, during the second time phase, the first heating element and the second heating element to a third target temperature higher than the first target temperature, and heat the third heating element to a fourth target temperature higher than the second target temperature.

14. The aerosol generating device according to claim 1, further comprising:
a chamber, configured to receive an aerosol generating article; and
an opening, wherein in use, the aerosol generating article is at least partially received in the chamber or removed from the chamber through the opening,
wherein the first heating element and/or the second heating element is closer to the opening than the third heating element.

15. The aerosol generating device according to claim 1, further comprising:
a circuit, configured to electrically connect one of a positive electrode and a negative electrode of the battery core to the second electrode, and electrically connect the other to the third electrode, so that the first heating element and the second heating element are connected in parallel and then simultaneously heated in series with the third heating element.

16. An aerosol generating device, configured to heat an aerosol generating article to generate an aerosol, and comprising:
a battery core, configured to supply power; and
a heater, configured to heat an aerosol generating article, wherein the heater comprises at least a first heating element, a second heating element, and a third heating element arranged in sequence along a longitudinal direction; and
a circuit, configured to:
electrically connect only the first heating element and the second heating element in parallel to the battery core during a first time phase, so that only the first heating element and the second heating element are simultaneously heated; and
electrically connect the first heating element, the second heating element, and the third heating element in parallel to the battery core during a second time phase, so that the first heating element, the second heating element, and the third heating element are simultaneously heated.

17. A heater for an aerosol generating device, comprising:
a tubular substrate;
a first heating element, a second heating element, and a third heating element arranged on the substrate in sequence along a longitudinal direction; and
a first electrode, a second electrode, and a third electrode, configured to guide a current on the heater,
wherein the first heating element and the second heating element are electrically connected in parallel between the first electrode and the second electrode; and the third heating element is connected between the first electrode and the third electrode.
